(19) United States
(12) Patent Application Publication
(10) Pub. No.: US 2005/0147948 A1
(43) Pub. Date: Jul. 7, 2005

(54) Instruction method for editorial service providers

(76) Inventor: Claudia Suzanne Stein, Santa Ana, CA (US)

Correspondence Address: Claudia Suzanne Stein;J-276, 17300 17th Street, Tustin, CA, 92780, US

(21) Appl. No.: 10/750,724

(22) Filed: Jan. 2, 2004

(51) Int. Cl. G09B 11/00; G09B 1/00; G09B 19/00

(52) U.S. Cl. 434/167

(57) ABSTRACT

An instruction method for editorial service providers, such as, for example, ghostwriters, traditional ghostwriters, content editors, line editors, “book doctors,” copy editors or proofreaders wherein the student learns to obtain and complete an editorial task for a third party. The method broadly comprises a plurality of steps, each of which builds on the previous step and is required for the following step, and the sum of which prepares the student for the occupation of professional book writer, a newly coined, trademark-pending designation

### COPYRIGHT STATEMENT

A portion of the disclosure of this patent document contains material that is subject to copyright protection. The copyright owner has no objection to the facsimile reproduction by anyone of the patent disclosure, as it appears in the Patent and Trademark Office patent files or records, but otherwise reserves all copyright rights whatsoever. A portion of the disclosure of this patent document contains material that is subject to trademark protection. The trademark owner has no objection to the facsimile reproduction by anyone of the patent disclosure, as it appears in the Patent and Trademark Office patent files or records, but otherwise reserves all trademark rights whatsoever.

### BACKGROUND OF INVENTION

This invention relates to methods of teaching writing, and more particularly to methods and systems for teaching editorial service providers wherein the student is exposed to the industry knowledge and the editorial and political skills necessary to pursue the occupation of professional book writer™, a trained editorial service career option.

With the advent of the personal computer, large numbers of people decided they now had the necessary tools to write and publish and book; consequently, the number of manuscripts in circulation through the hands of literary agents and traditional publishers rose from tens of thousands every year to millions. Due to the ease and convenience of computerized word-processing and the increasingly higher number of functionally illiterate high school and college graduates every year, the pool of editorial service providers available to adequately serve the every expanding pool of inexperienced authors must necessarily increase. Accordingly, the response to the increase in available manuscripts has given rise to tens of thousands of freelance editors, ghostwriters, book shepherds and sundry other editorial-service providers. Previously, no standard of excellence, skill or raw ability has ever been set and no process, method or system has ever been available to train that pool of editorial service providers. Consequently, the combination of millions of inexperienced authors coupled with tens of thousands of untrained editorial service providers has, in turn, resulted in a surfeit both of published and unpublished works of a lower quality, thereby effecting a lower standard of information literacy.

Due to the above-identified and other problems and disadvantages in the art, a need exists for an improved method of teaching editorial service providers so as to raise the level of competency of the profession and thereby effect a higher standard of information literacy in future published nonfiction and fiction works.

### BRIEF DESCRIPTION OF DRAWINGS

The attached drawings are for the purposes of illustration and description only and are not intended as a definition of the limits of the present invention. They relate to the description of the preferred embodiment of the invention below, wherein:

FIG. 1 shows the parameters of editorial service providers, and specifically those that apply to Professional Book Writers™.

FIG. 2 shows the parameters of the Concept module of the Business section of the method.

FIG. 3 shows the parameters of the Ethics and Nonfiction Writing modules of the Business section of the method.

FIG. 4 shows the parameters of the Fiction Writing module of the Business section of the method.

FIG. 5 shows the parameters of the Editing module of the Business section of the method.

FIG. 6 shows the parameters of the Publishing module of the Business section of the method.

FIG. 7 shows the parameters of the Distribution module of the Business section of the method.

FIG. 8 shows the parameters of the Marketing module of the Business section of the method.

FIG. 9 shows the parameters of the Promotion and Fulfillment modules of the Business section of the method.

FIG. 10 shows the parameters of the Manuscript Analysis and Nonfiction Analysis & Recommendations modules of the Skills section of the method.

FIG. 11 shows the parameters of the Fiction Analysis & Recommendations module of the Skills section of the method.

FIG. 12 shows the detailed parameters of the Nonfiction and Fiction A&R processes of the Skills section of the method.

FIG. 13 shows the parameters of the 3^{rd}-Party Voice and Ghostwriting modules of the Skills section of the method.

FIG. 14 shows the parameters of the Submissions module of the Skills section of the method.

FIG. 15 shows the parameters of the Professional Image, Reasonable Fees, and Initial Contact modules of the Politics section of the method.

FIG. 16 shows the parameters of the Client/Project Assessment, Bids, and Contracts modules of the Politics section of the method.

FIG. 17 shows the parameters of the Maintaining Authority and Handling Difficulties modules of the Politics section of the method.

### DETAILED DESCRIPTION

The current invention is a method for teaching editorial service providers, such as, for example, ghostwriters, traditional ghostwriters, content editors, line editors, “book doctors,” copy editors or proofreaders wherein the student learns to obtain and complete an editorial task for a third party. The method broadly comprises a plurality of steps, each of which builds on the previous steps and is required for the following step, and the sum of which prepares the student for the occupation of professional book writer™, a newly coined editorial-service designation. The method is segmented into three sections: business, skills, and politics, each of which requires the knowledge acquired in the previous section to proceed with the course of study.

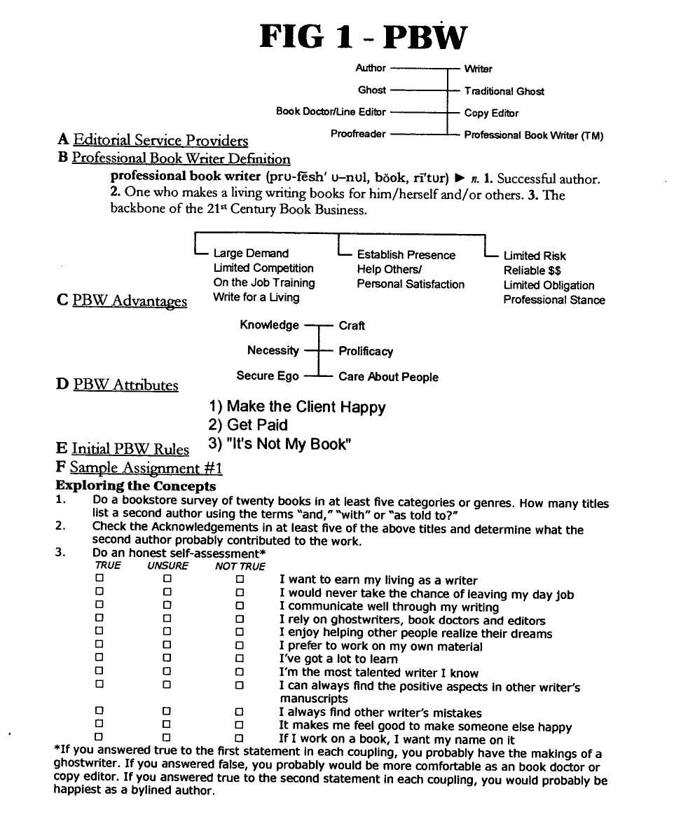

Referring to FIG. 1, the student begins the business section of this method. The student is shown the possible designations inherent to book industry editorial service as illustrated in Box A, including the newly coined designation “Professional Book Writer™” defined in Box B which comprises the full range of the other seven designations inherent to the industry plus additional skills and knowledge. Specifically, the student is shown the fundamental advantages of professional book writing over other types of freelance, employed, or untrained writing avenues and the range of abilities and perspective the student must have and/or understand to continue with the course of study. FIG. 1 Box F is an example of how the student can explore these concepts to determine his or her suitability for this course of study.

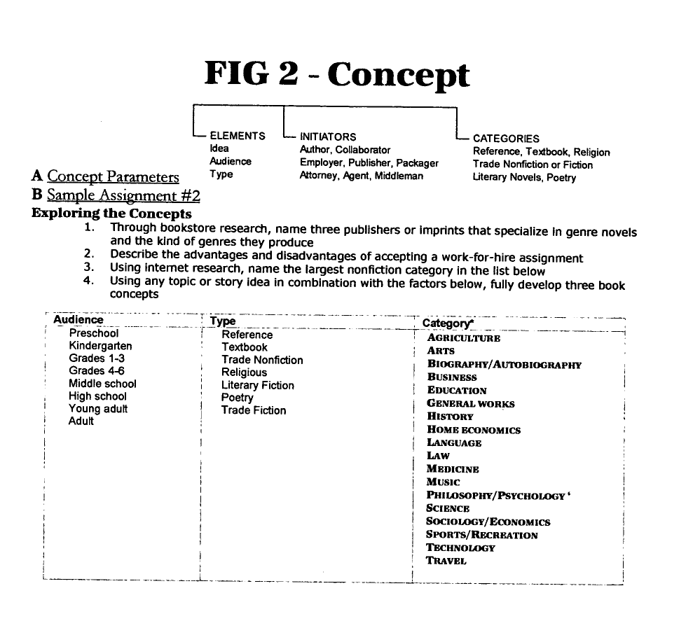

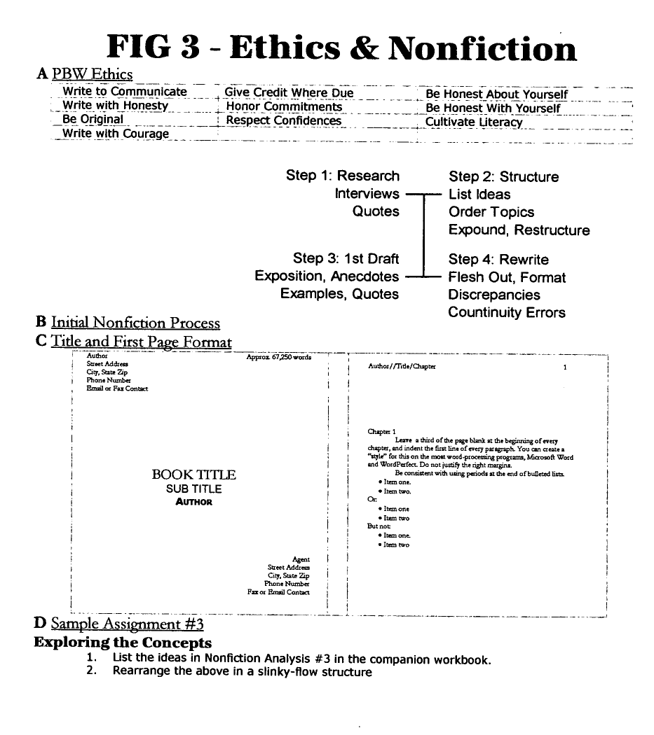

Beginning with FIG. 2, the student is shown the fundamental steps and procedures of this method for categorizing trade books as well as an example of how to explore these concepts through practical module-specific exercises. Moving onto FIG. 3, the student is shown the ethics inherent to providing the skills and procedures being studied as well as the fundamental steps and procedures of this method for creating a nonfiction manuscript, incorporating the knowledge acquired over the course of study illustrated in FIG. 2, wherein the student is encouraged to think of a manuscript from an objective and non-academic perspective and provided with a specific technique with which to correct a previously written draft. Specifically, the student is shown the fundamental steps and procedures for how to discover whether the ideas in the manuscript constitute a “slinky flow” and, if not, how to establish that “slinky flow”; how to discover if the manuscript is sufficiently balanced between the four elements of nonfiction books exposition, anecdotes, examples and quotes and how to revise the manuscript to include those elements, develop undeveloped ideas, eliminate discrepancies and continuity errors, transition into and out of appropriate digressions and accomplish other writing improvements so as to elevate the standard of information literacy in the manuscript. Additionally, the student is shown the fundamental steps and procedures for formatting the manuscript for submission to a literary agent or publisher. FIG. 3 Box D is an example of how the student can explore these concepts through practical module-specific exercises.

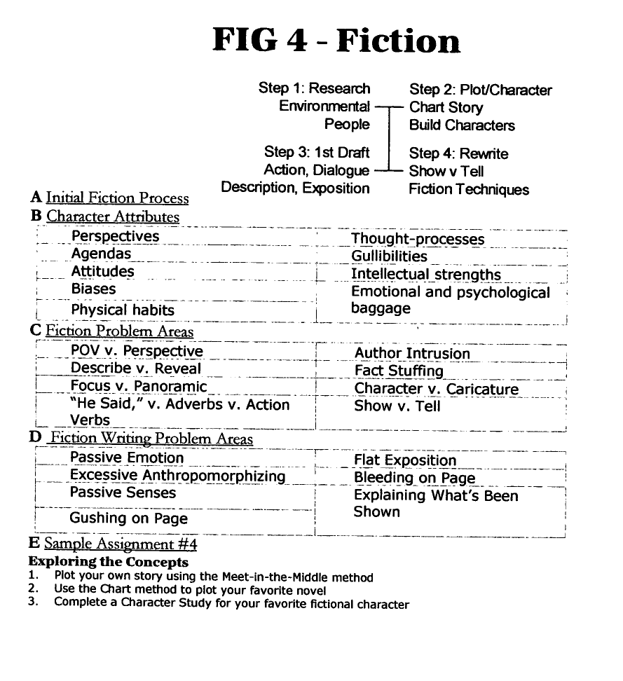

Moving onto FIG. 4, the student is shown the fundamental steps and procedures of this method for creating a fiction manuscript incorporating the knowledge acquired over the course of study illustrated in FIG. 2 and appropriate techniques acquired in FIG. 3, wherein the student is encouraged to think of a novel from an objective and non-academic perspective and provided with a specific technique with which to correct a previously written draft. Specifically, the student is shown how to discover whether the characters in the novel are fully developed or one-dimensional, and how to utilize the author's vision, the student's own life observations, and suggested components to amend, correct, or develop those characters; whether the plot is fully developed or a flat-line sequence-of-events, and how to utilize the author's vision, the characterizations previously developed, and suggested components to amend, correct or develop the plot; whether the dialogue is conversational or static and how to utilize the author's vision, the student's own life observations, and suggested components to amend, correct or develop that dialogue, and accomplish other writing improvements so as to elevate the standard of information literacy in the manuscript. Additionally, the student is shown the fundamental steps and procedures of this method for improving character, descriptive, expository, and action-oriented fictional prose and thus elevating the standard of information literacy in the manuscript. FIG. 4 Box E is an example of how the student can explore these concepts through practical module-specific exercises.

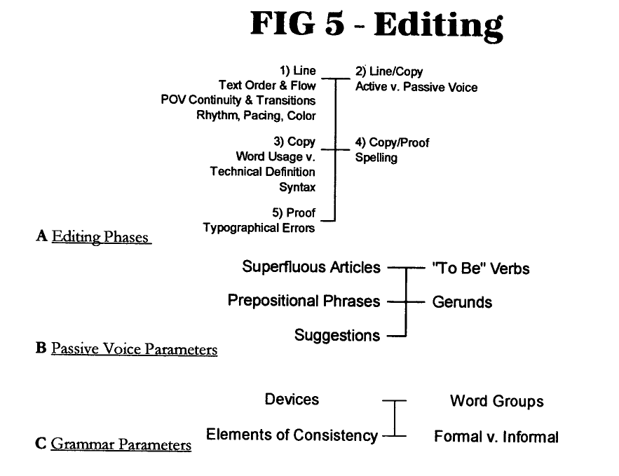

Referring to FIG. 5, the student is shown the fundamental steps and procedures of this method for editing a nonfiction or fiction manuscript incorporating the knowledge acquired over the course of study illustrated in FIGS. 2, 3, and 4, wherein the student is encouraged to think of the task as a five-stage procedure, not to be undertaken until all development, writing and revision steps are fully completed and requiring multiple drafts of the manuscript to complete the task. Specifically, the student is shown how to adjust text order and flow; differentiate between appropriate and inappropriate point-of-view changes and adjust or amend those changes that are inappropriate; differentiate between passive and active voice and adjust or amend that voice as appropriate; identify the need for or lack of transitional phrases, lines, or paragraphs and provide as necessary; differentiate between appropriate and inappropriate word usage and adjust or amend the verbiage as necessary; and identify pacing, color and rhythmic errors and adjust or amend those phrases, lines, or paragraphs as appropriate. Additionally, the student is shown the fundamental elements of syntax and spelling, and when and how to correct those errors as appropriate, thus elevating the standard of information literacy in this manuscript. FIG. 5 Box D is an example of how the student can explore these concepts through practical module-specific exercises.

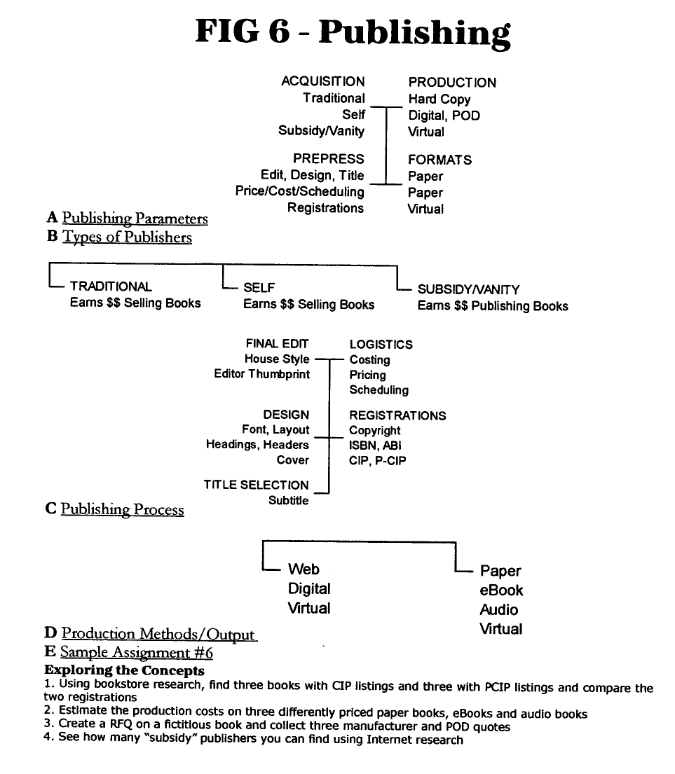

Referring now to FIG. 6, the student is shown the fundamental steps and procedures of this method for understanding how the manuscripts created over the course of study illustrated in FIGS. 2 through 5 are selected and produced as trade books, wherein the student is encouraged to think of the process as the natural extension of creating the manuscript in accordance to the course of study illustrated in FIGS. 2-5 and thus so advise his or her clients. Specifically, the student is shown how to differentiate between types of publishers, publishing formats, and production methods; how and what to advise clients regarding the publishing process including costs and responsibilities concerning design, titling, pricing, scheduling, and industry registrations; and how to understand and guide clients through the industry's technological terminology. FIG. 6 Box E is an example of how the student can explore these concepts through practical module-specific exercises.

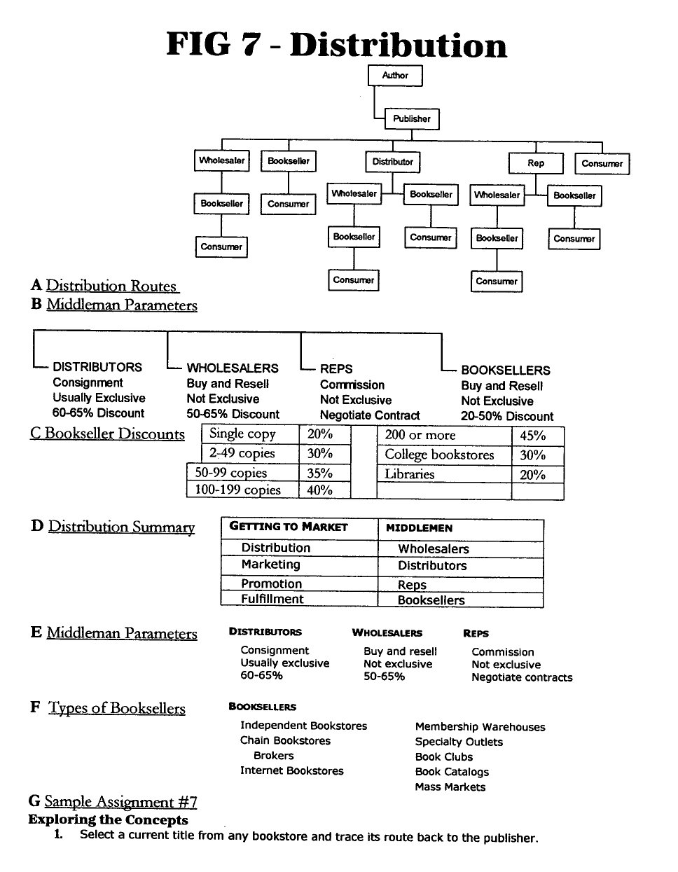

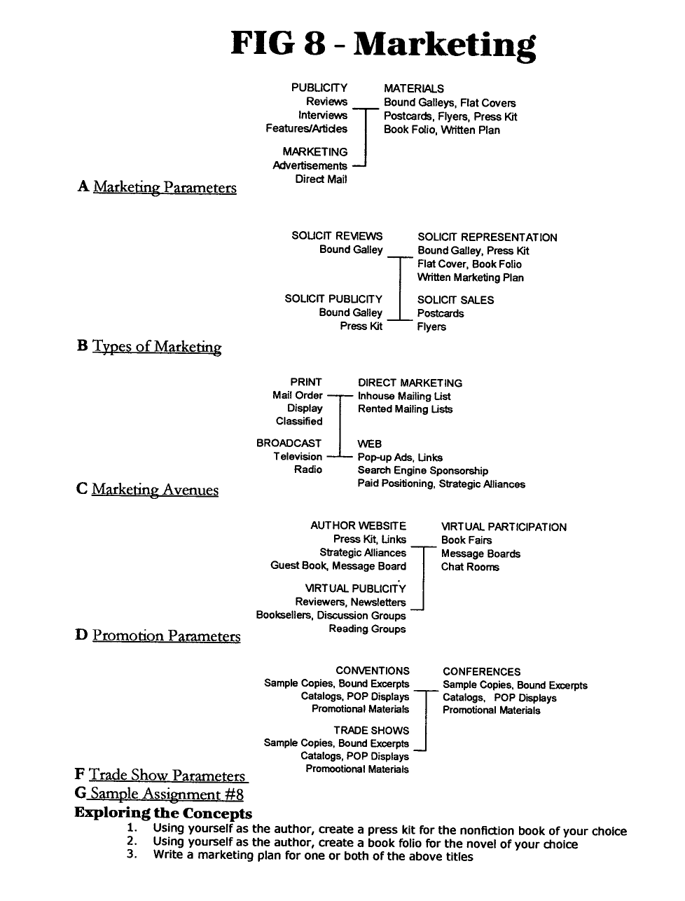

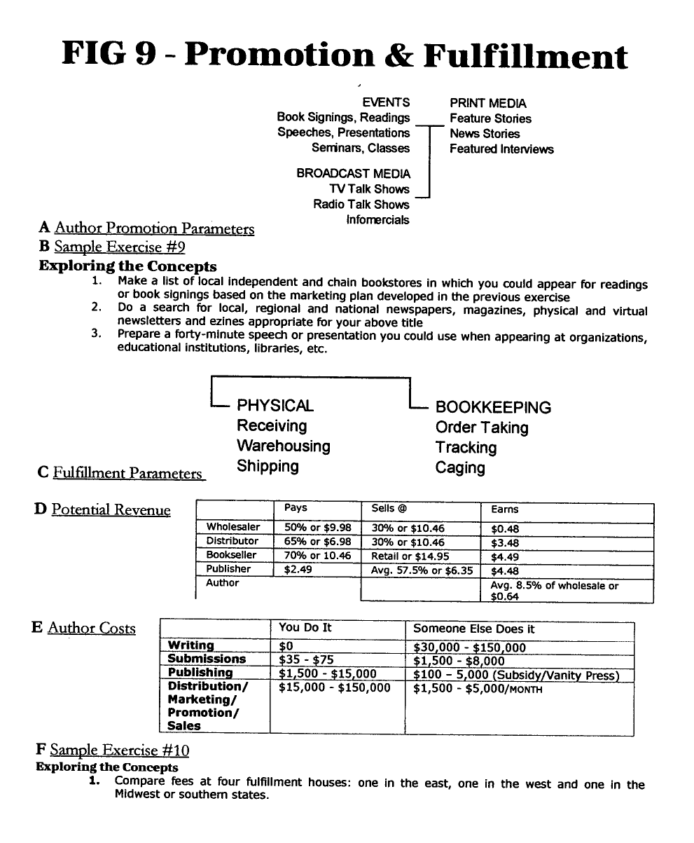

With reference to FIGS. 7, 8, and 9, the student is shown the fundamental steps and procedures of this method for understanding how the manuscripts created and published over the course of study illustrated in FIGS. 2 through 6 are distributed, marketed, promoted, and sold to the consumer, wherein the student is encouraged to think of the process as the natural extension of creating the manuscript in accordance to the course of study illustrated in FIGS. 2-5 and thus so advise his or her clients. Specifically, the student is shown the array of distribution routes and the industry middlemen who facilitate those routes; the costs and marketing and promotion campaigns necessary to impact those routes; and the marketing and promotion materials necessary to effect those campaigns. Additionally, the student is shown how to create those necessary marketing and promotion materials based on knowledge acquired over the course of study illustrated in FIGS. 2 through 6, how to incorporate the five potential marketing routes into a marketing campaign, how to incorporate the three potential promotion routes into an author-promotion campaign, and how to disburse the marketing and promotion materials developed above within those campaigns. FIG. 7 Box G, FIG. 8 Box G, FIG. 9 Box B and FIG. 9 Box G are examples of how the student can explore these concepts through practical module-specific exercises.

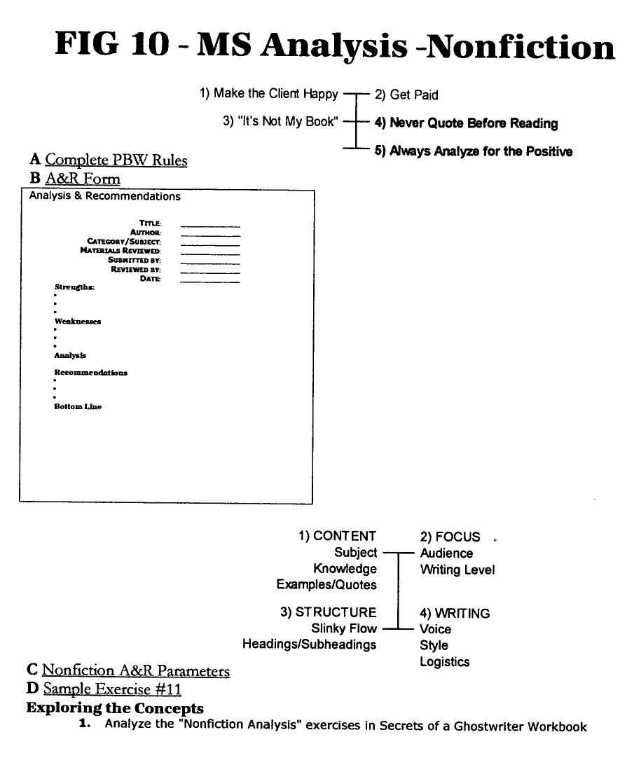

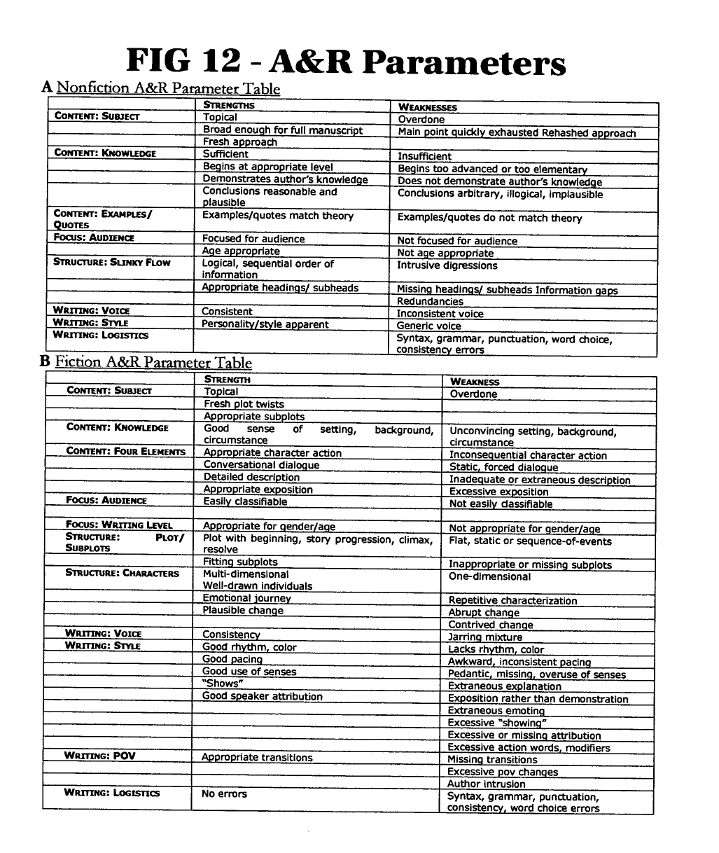

Moving onto FIG. 10, the student enters the skills-acquisition section of this method, wherein the student is shown the fundamental steps and procedures of this method for how to incorporate the knowledge acquired over the course of study illustrated in FIGS. 1-9 to analyzing a nonfiction manuscript so as to differentiate those elements that do or could increase the manuscript's potential in the trade-book publishing, distribution, marketing, and promotion process from those elements that need to be adjusted, amended, or corrected to support that potential. Specifically, the student is shown how to approach the analysis with a professional-book-writing perspective based on the knowledge acquired over the course of study illustrated in FIG. 1; how to apply the industry knowledge acquired over the course of study illustrated in FIGS. 6-9 and the nonfiction-manuscript craft knowledge acquired over the course of study illustrated in FIGS. 2, 3, and 5, detailed in FIG. 12 Box A, to that analysis. FIG. 10 Box D is an example of how the student can explore these concepts through practical module-specific exercises.

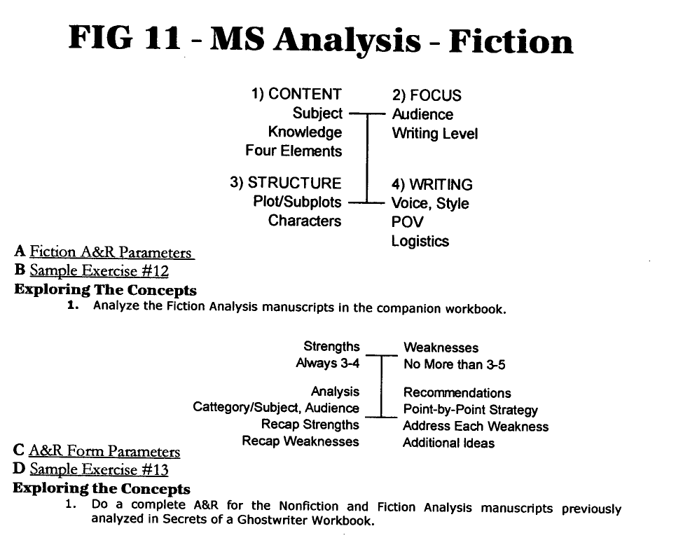

Referring to FIG. 11, the student is shown the fundamental steps and procedures of this method for how to incorporate the knowledge acquired over the course of study illustrated in FIGS. 1-9 to analyzing a fiction manuscript so as to differentiate those elements that do or could increase the manuscript's potential in the trade-book publishing, distribution, marketing, and promotion process from those elements that need to be adjusted, amended, or corrected to support that potential. Specifically, the student is shown how to approach the analysis with a professional-book-writing perspective based on the knowledge acquired over the course of study illustrated in FIG. 1; how to apply the industry knowledge acquired over the course of study illustrated in FIGS. 6-9 and the fiction-manuscript craft knowledge acquired over the course of study illustrated in FIGS. 2, 4, and 5, detailed in FIG. 12 Box B, to that analysis. FIG. 11 Box D is an example of how the student can explore these concepts through practical module-specific exercises.

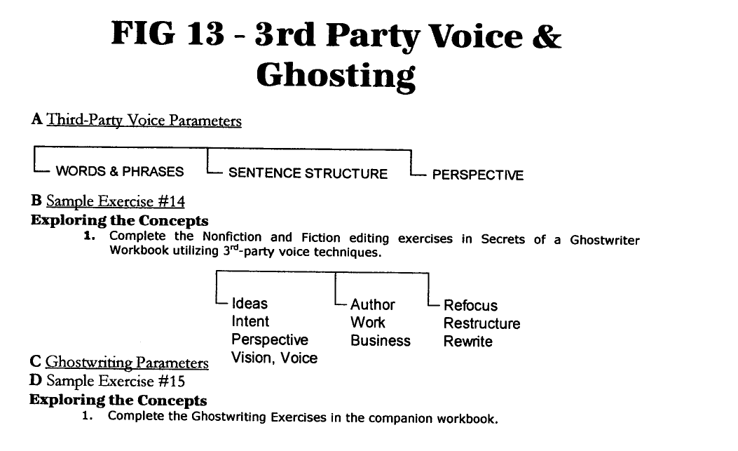

Moving on to FIG. 13, the student is shown the fundamental steps and procedures of this method maintaining someone else's voice and ghostwriting, wherein the student is encouraged to master two new skill sets not previously disclosed in any scholastic or trade text, process, or method. Specifically, the student is shown how to apply the knowledge acquired over the course of study illustrated in FIGS. 2-5 to a nonfiction or fiction manuscript without disturbing the original author's intent, perspective, focus, vision, or voice. Additionally, the student is shown how the knowledge acquired over the course of study illustrated in FIGS. 2-5 must be mastered prior to or concurrent with mastering the skills illustrated in FIG. 13. FIG. 13 Boxes B and D are examples of how the student can explore these concepts through practical module-specific exercises.

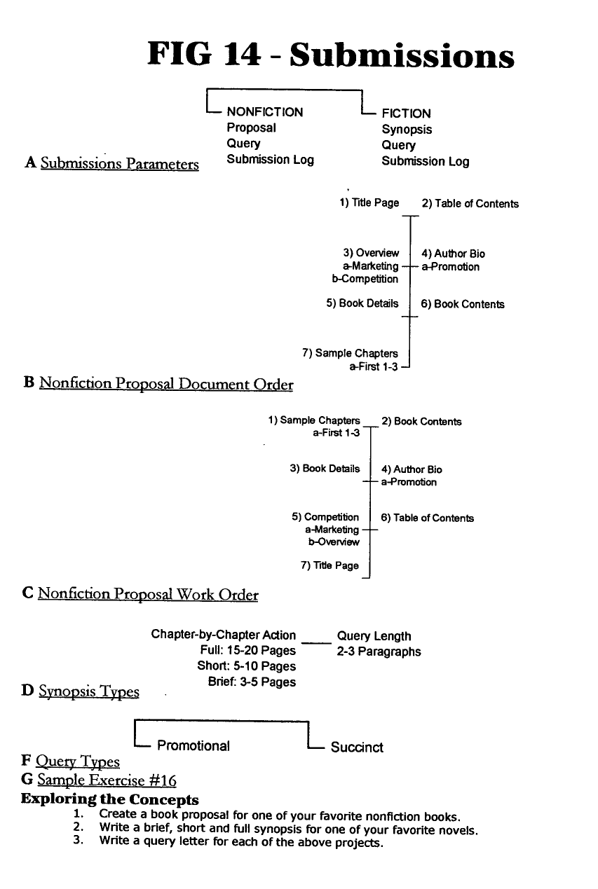

Referring to FIG. 14, the student is shown the fundamental steps and procedures of this method for how to apply the knowledge acquired over the course of study illustrated in FIGS. 1-13 to producing effective submission materials, wherein the student is encouraged to think of the of the process as the natural extension of creating the manuscript in accordance to the course of study illustrated in FIGS. 2-5 and thus so advise and/or provide service to his or her clients. Specifically, the student is shown how to utilize the industry knowledge acquired over the course of study illustrated in FIGS. 6-9 and the nonfiction-manuscript knowledge and skills acquired over the course of study illustrated in FIGS. 2, 3, and 5 to create a nonfiction book proposal in reverse order from its final form; how to utilize the industry knowledge acquired over the course of study illustrated in FIGS. 6-9 and the fiction-manuscript knowledge and skills acquired over the course of study illustrated in FIGS. 2, 3, and 4 to create a submission synopsis; and how to utilize the industry knowledge acquired over the course of study illustrated in FIGS. 6-9 to create an assortment of effective query letters. Additionally, the student is shown how to advise a client about finding and working with a literary agent. FIG. 14 Box G is an example of how the student can explore these concepts through practical module-specific exercises.

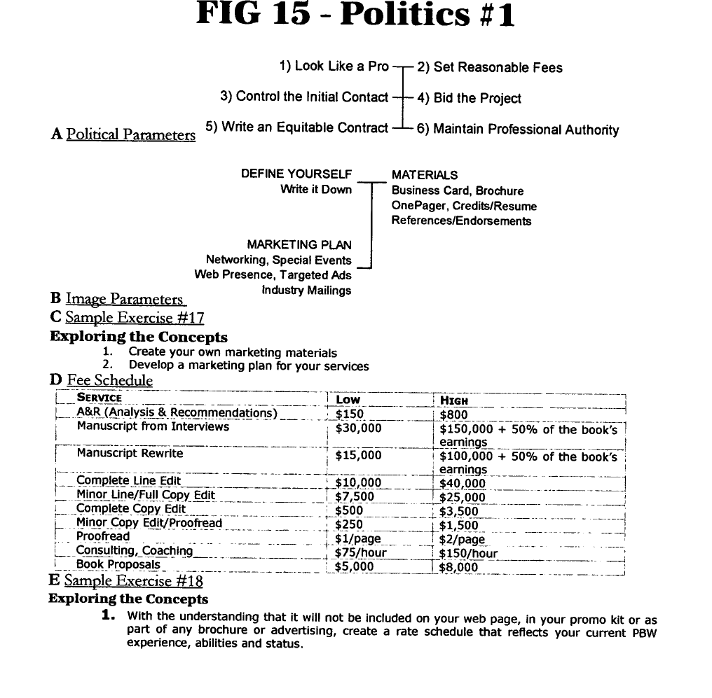

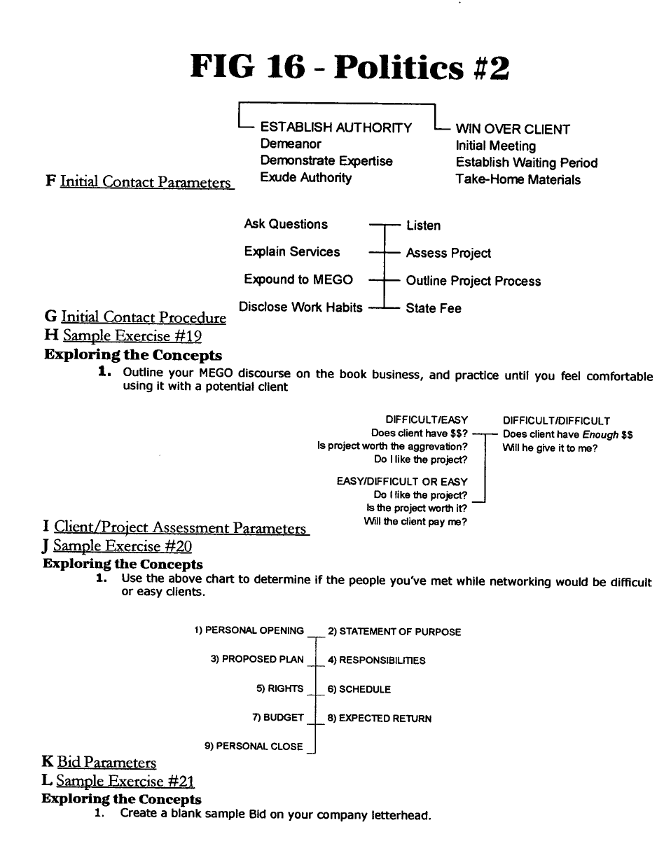

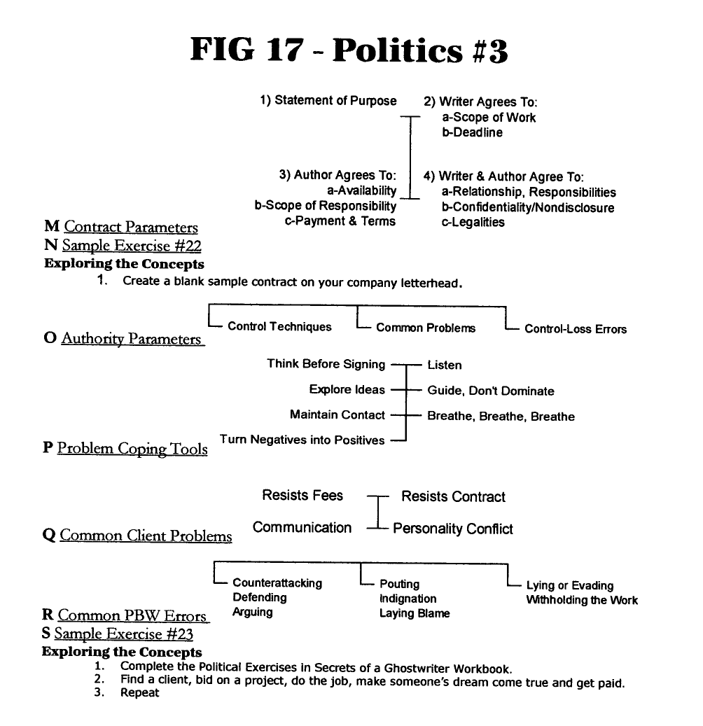

Moving on to FIGS. 15-17, the student enters the politics section of this method, wherein the student is encouraged to think of the knowledge acquired over the course of study illustrated in FIGS. 1-16 as the foundation for a practical vocation. The student is shown the fundamental steps and procedures for how to incorporate the knowledge and skills acquired over the course of study illustrated in FIGS. 1-14 to establish and maintain a freelance career as a Professional Book Writer™. Specifically, the student is shown how to create a professional image, set reasonable fees based upon the knowledge acquired over the course of study illustrated in FIGS. 10-16, establish a posture of authority based upon the knowledge and skills acquired over the course of study illustrated in FIGS. 1-16, assess clients and their projects based upon the knowledge and skills acquired over the course of study illustrated in FIGS. 2-5, bid projects based upon the knowledge and skills acquired over the course of study illustrated in FIGS. 2-16, write equitable contracts based upon the knowledge acquired over the course of study illustrated in FIGS. 6-9, and maintain a posture of authority and handle client/project difficulties based upon the knowledge acquired over the course of study illustrated in FIGS. 1-17. FIG. 15 Boxes C, E, and H; FIG. 16 Boxes J, L, and N; and FIG. 17 Box S are is an examples of how the student can explore these concepts through practical module-specific exercises.

Although the current invention has been described with respect to specific details of a certain preferred embodiment thereof, it is not intended that such details limit the scope of this patent other than as expressly set forth in the following claims.

1. An instruction method to train writers in the occupation of Professional Book Writer™ wherein the student learns to provide editorial services to fiction and nonfiction book authors, comprising: occupational introduction; industry information; editorial skills which rely upon industry information; political skills which rely upon industry information and editorial skills.
a method according to claim 1 wherein occupational introduction comprises a plurality of sets of parameters;
1. a method according to claim 2 wherein those sets of parameters are demonstrated in charts, tables and sample assignments;
1. a method according to claim 1 wherein industry information is categorized into eight modules, each with a plurality of sets of parameters;
1. a method according to claim 4 wherein those sets of parameters are demonstrated in charts, tables and sample assignments;
a method according to claim 1 wherein editorial skills are categorized into three modules, each with a plurality of sets of parameters;
a method according to claim 6 wherein those sets of parameters are demonstrated in tables, forms and sample assignments;
a method according to claim 1 wherein political skills are categorized into eight modules, each with a plurality of sets of parameters;
a method according to claim 8 wherein those sets of parameters are demonstrated in charts, tables, forms and sample assignments;
a method according to claim 1 wherein a standard of information literacy on the part of the service provider is set.
a method according to claim 10 wherein a standard of information literacy on the part of serviced authors is set.
1. a kit for instructing writers in the occupation of providing Professional Book Writer™ editorial services to fiction and nonfiction book writers, comprising the combination of: a book including chapters discussing and demonstrating the occupational introduction and including charts, tables and sample assignments; a book including chapters each discussing and demonstrating one of the eight sets of parameters of the industry and including charts, tables and sample assignments; a book including chapters each discussing and demonstrating one of the three sets of parameters of editorial skills and seven sets of parameters of political skills and including charts, tables, forms and sample assignments; a companion workbook including sample manuscripts, exercises, and political situations, each of which relate to one or more of the sample assignments noted above.
